(19) United States
(12) Patent Application Publication
(10) Pub. No.: US 2019/0230299 A1
(43) Pub. Date: Jul. 25, 2019

(54) IMAGING APPARATUS AND RADIATION IMAGING SYSTEM

(71) Applicant: CANON KABUSHIKI KAISHA, Tokyo (JP)

(72) Inventor: Koichi Ohta, Yokohama-shi (JP)

(21) Appl. No.: 16/244,500

(22) Filed: Jan. 10, 2019

(30) Foreign Application Priority Data
Jan. 22, 2018 (JP) 2018-008165

(51) Int. Cl. H04N 5/32; H04N 5/378; H04N 5/376; G01N 23/04

(52) U.S. Cl. CPC H04N 5/32; G01N 23/04; H04N 5/3765; H04N 5/378

(57) ABSTRACT

An imaging apparatus includes a pixel array in which a plurality of pixels are arranged, each of the plurality of pixels including a conversion unit configured to convert radiation or light into charges, an amplification unit configured to amplify a signal corresponding to the charges, a reset unit configured to reset the conversion unit and the amplification unit, first and second holding units configured to hold the amplified signal, and a control unit. The control unit performs control including first control in which a signal corresponding to charges converted by the conversion unit during the pixel array being irradiated by radiation or light is held in the first holding unit, and second control in which a signal corresponding to charges in the conversion unit during the pixel array being not irradiated by radiation or light is held in the second holding unit.

### BACKGROUND OF THE INVENTION

### Field of the Invention

The present invention relates to an imaging apparatus and a radiation imaging system.

### Description of the Related Art

In the field of digital X-ray imaging apparatuses, a large-area flat panel type imaging apparatus including an equal-magnification optical system using a photoelectric conversion element, instead of an image intensifier, is widely used in order to increase the resolution, reduce the volume, and suppress image distortion. As one flat panel sensor of the equal-magnification optical system to be used in the imaging apparatus, there is a large-area flat panel sensor obtained by two-dimensionally connecting photoelectric conversion elements produced by a CMOS semiconductor fabrication process on a silicon semiconductor wafer.

Japanese Patent Laid-Open No. 2002-344809 discloses the configuration of a pixel array in which a vertical shift register and horizontal shift register are arranged as readout control circuits together with two-dimensionally arrayed photoelectric conversion elements. An apparatus disclosed in Japanese Patent Laid-Open No. 2002-344809 uses a large-area flat panel sensor obtained by two-dimensionally connecting pixel arrays. Japanese Patent Laid-Open No. 2002-344809 also discloses an imaging apparatus in which two holding units of each pixel in a sensor array obtain a signal and reset voltage, and noise removal is performed by the difference between these signals. Japanese Patent Laid-Open No. 2016-82255 discloses a technique in which in each pixel of a sensor array, a noise component caused by a temperature variation which can be contained in a signal is reduced by using a noise signal based on a reset voltage held in two holding units.

### SUMMARY OF THE INVENTION

The present invention has been made in consideration of the above situation, and provides a technique advantageous in reducing noise which is generated in an imaging apparatus and fluctuates with time.

According to an aspect of the present invention, the present invention provides an imaging apparatus comprising: a pixel array in which a plurality of pixels are two-dimensionally arranged, each of the plurality of pixels including a conversion unit configured to convert radiation or light into charges, an amplification unit configured to amplify a signal corresponding to the charges, a reset unit configured to reset the conversion unit and the amplification unit, and first and second holding units configured to hold the amplified signal; and a control unit configured to control the pixel array, the control unit repetitively performing control including first control in which, between two consecutive reset operations performed by the reset unit, a first signal corresponding to charges converted by the conversion unit in a first period during which the pixel array is irradiated by radiation or light is held in the first holding unit, and second control which is different from the first control and in which, between two consecutive reset operations performed by the reset unit, a second signal corresponding to charges in the conversion unit in a second period during which the pixel array is not irradiated by radiation or light is held in the second holding unit, wherein a captured image is generated based on the first signal, a dark image is generated based on the second signal, and the captured image is corrected by the dark image.

Further features of the present invention will become apparent from the following description of exemplary embodiments with reference to the attached drawings.

### BRIEF DESCRIPTION OF THE DRAWINGS

FIG. 1 is a circuit diagram for explaining a pixel configuration of an embodiment of the present invention;

FIGS. 2A and 2B are circuit diagrams for explaining the arrangements of a pixel array and signal readout unit of the embodiment of the present invention;

FIG. 3 is a schematic view for explaining the configuration of a radiation imaging system of the embodiment of the present invention;

FIG. 4 is a timing chart showing the first embodiment of the present invention;

FIG. 5 is a flowchart for explaining the first embodiment of the present invention;

FIG. 6 is a timing chart showing the second embodiment of the present invention;

FIG. 7 is a flowchart for explaining the second embodiment of the present invention;

FIG. 8 is a flowchart for explaining details of imaging mode setting of the present invention;

FIG. 9 is a circuit diagram for explaining the arrangement of a signal readout unit according to the third embodiment of the present invention; and

FIG. 10 is a flowchart for explaining the third embodiment of the present invention.

### DESCRIPTION OF THE EMBODIMENTS

Embodiments of the present invention will be explained below with reference to the accompanying drawings. The same reference numerals denote the same elements throughout the various embodiments, and a repetitive explanation thereof will be omitted. Also, these embodiments can be changed and combined as needed.

### First Embodiment

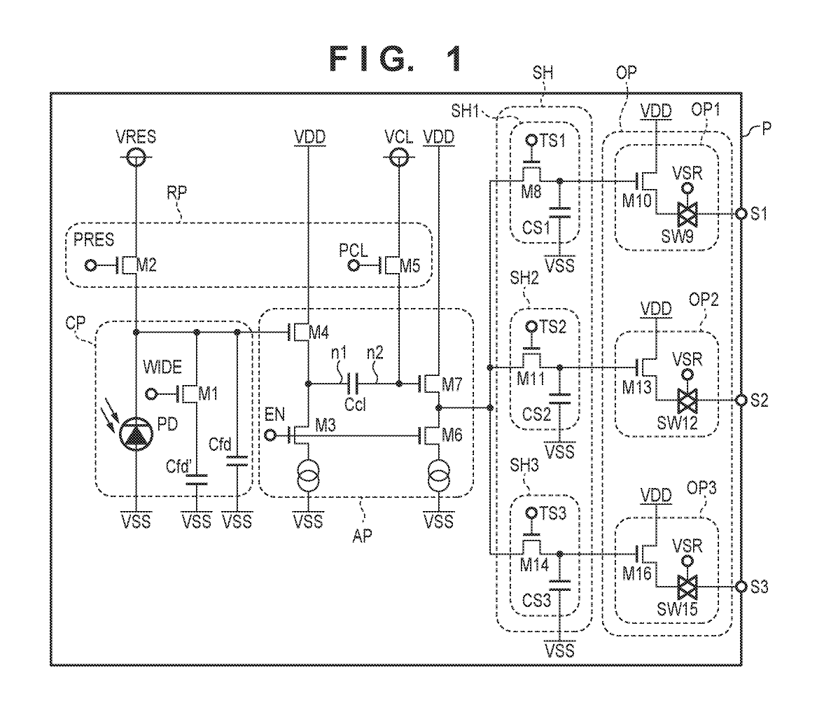

Each component used in an imaging apparatus 100 of the embodiment of the present invention will be explained. First, an outline of one pixel P will be explained with reference to a circuit diagram shown in FIG. 1. The pixel P includes a conversion unit CP, an amplification unit AP, a reset unit RP, holding units SH1 to SH3, and output units OP1 to OP3.

The conversion unit CP includes a photodiode PD, a transistor M1, a floating diffusion capacitor Cfd (to be referred to as an FD capacitor Cfd hereinafter), and an additional capacitor Cfd′ for sensitivity switching. A scintillator for converting radiation into light converts radiation incident on the imaging apparatus 100 into light which is generated in accordance with the incident radiation. The photodiode PD is an example of a photoelectric conversion element, and converts the light generated in accordance with the radiation into charges. That is, the scintillator for converting radiation into light and the photoelectric conversion element for converting light into charges convert radiation into charges. Instead of the scintillator, an element which directly converts radiation into charges may also be used as a conversion element.

In the pixel P, the photodiode PD generates charges whose amount corresponds to light, and the voltage of the FD capacitor Cfd, which corresponds to the generated charge amount, is output to the amplification unit AP. The capacitor Cfd′ for sensitivity switching is used to switch the sensitivities of the pixel P. The capacitor Cfd′ is connected to the photodiode PD via the transistor M1 (switch). The transistor M1 changes to a conductive state when a WIDE signal is activated, and a voltage corresponding to the charge amount and obtained by the combined capacitance of the FD capacitor Cfd and capacitor Cfd′ is output to the amplification unit AP. That is, the sensitivities of the conversion unit CP can be switched by controlling the conductive state of the transistor M1. When the transistor M1 is OFF, the FD capacitor Cfd is the only capacitance of floating diffusion, so the conversion unit CP increases the sensitivity and outputs a high-sensitivity signal. When the transistor M1 is in the conductive state, the capacitor Cfd′ for sensitivity switching is added in parallel to the FD capacitor Cfd, so the conversion unit CP decreases the sensitivity and outputs a low-sensitivity signal.

The amplification unit AP includes a control transistor M3, an amplification transistor M4, a clamp capacitor Ccl, a control transistor M6, an amplification transistor M7, and constant current sources. The control transistor M3, the amplification transistor M4, and the constant current source (for example, a current-mirror transistor circuit) are connected in series, thereby forming a current path. When an enable signal EN to be input to the gate of the control transistor M3 is activated, the amplification transistor M4 which receives the voltage from the conversion unit CP is turned on. The amplification transistor M4 thus forms a source follower circuit, and outputs a voltage obtained by amplifying the voltage from the conversion unit CP. This voltage output from the amplification transistor M4 is input to the amplification transistor M7 via the clamp capacitor Ccl. The control transistor M6, the amplification transistor M7, and the constant current source are connected in series, thereby forming a current path. When the enable signal EN to be input to the gate of the control transistor M6 is activated, the amplification transistor M7 which receives the output voltage from the amplification transistor M4 is turned on. The amplification transistor M7 thus forms a source follower circuit, and outputs a voltage obtained by amplifying the voltage from the amplification transistor M4. The clamp capacitor Ccl is arranged in series between the source electrode of the amplification transistor M4 and the gate electrode of the amplification transistor M7. A clamp operation performed by the clamp capacitor Ccl will be explained together with the reset unit RP to be explained below.

The reset unit RP includes a reset transistor M2 and a reset transistor M5. The reset transistor M2 changes to a conductive state when a reset voltage PRES is activated, and supplies a predetermined voltage VRES (a reset voltage) to the photodiode PD, thereby resetting (initializing) the charges of the photodiode PD, and resetting the voltage to be output to the amplification unit AP. The reset transistor M5 resets the voltage to be output from the amplification transistor M7 by supplying a predetermined potential to a connection node between the clamp capacitor Ccl and the gate electrode of the amplification transistor M7. When the reset transistor M2 performs resetting, a voltage corresponding to the voltage from the conversion unit CP upon resetting is input to an input terminal n1 of the clamp capacitor Ccl. In addition, when a clamp signal PCL is activated, the reset transistor M5 changes to a conductive state, and a clamp voltage VCL as a predetermined potential is input to an output terminal n2 of the clamp capacitor Ccl. Thus, a potential difference produced between the two terminals of the clamp capacitor Ccl is clamped as a noise component, and a voltage having changed due to the generation and accumulation of charges in the photodiode PD after that is output as a signal component. This is the clamp operation using the clamp capacitor Ccl, and the clamp operation suppresses kTC noise generated in the conversion unit CP and a noise component such as offset noise of the amplification transistor M4. Also, the reset operation can reset the FD capacitor and holding units SH1 to SH3.

The conversion unit CP and the amplification unit AP form a signal generation unit which converts radiation into charges, amplifies a signal based on the charges accumulated in the conversion unit CP, and outputs the amplified signal. This signal based on the charges accumulated in the conversion unit CP will be called an accumulation signal. The charges accumulated in the conversion unit CP contain charges generated in accordance with radiation, and charges (charges based on a so-called dark current) generated independently of radiation. The accumulation signal generated in accordance with radiation is output as the above-described high-sensitivity signal or low-sensitivity signal. Also, a signal based on charges obtained by accumulation of noise or the like produced when the conversion unit CP is not exposed to (not irradiated with) radiation will be called a dark current signal. A signal generated by this signal generation unit when the reset unit RP resets the signal generation unit to a state before charge accumulation will be called a reset signal. As described previously, the signal generation unit is reset by resetting the potential of the photoelectric conversion element PD and the potential of the output terminal n2 of the clamp capacitor Ccl.

The accumulation signal and reset signal will collectively be called pixel signals. A pixel signal output from the signal generation unit after charges are accumulated in the conversion unit CP will be referred to as an accumulation signal, and a pixel signal output from the signal generation unit in the reset state will be referred to as a reset signal.

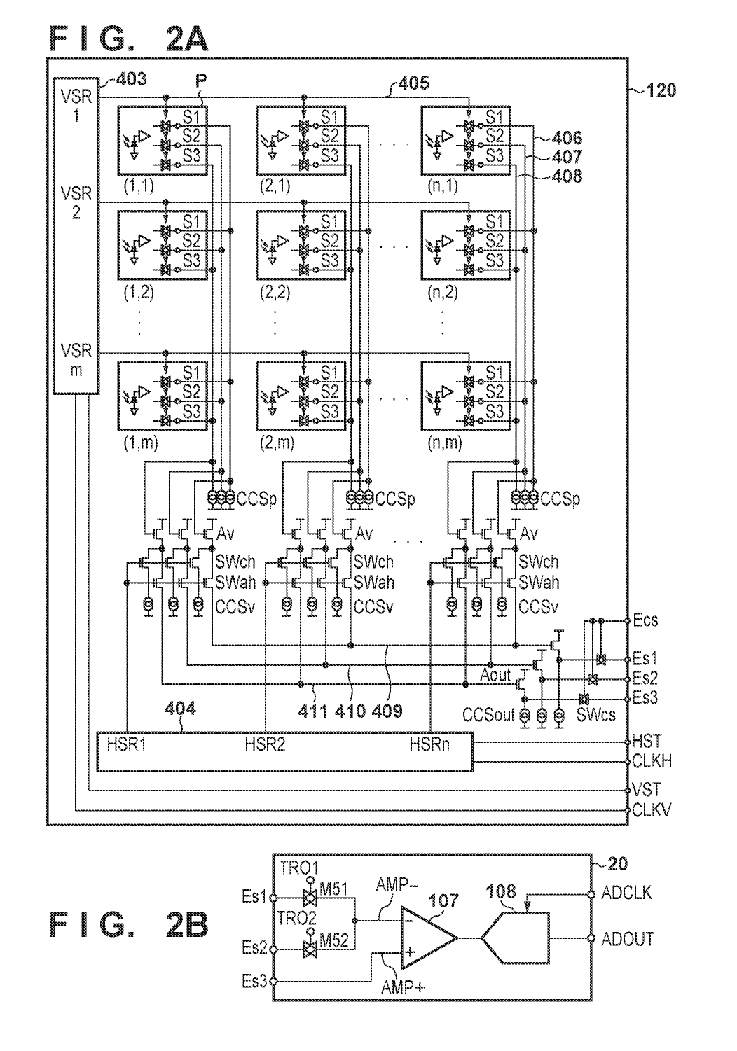

The holding unit SH1 is a unit which holds a pixel signal output from the amplification unit AP, and is a sample-and-hold circuit including a transfer transistor M8 and a capacitor CS1. More specifically, the pixel signal is transferred to and held in the capacitor CS1 by switching the states (the conductive state and the non-conductive state) of the transfer transistor M8 by using a sample-and-hold control signal TS1. The output unit OP1 includes a signal amplification transistor M10 and an output switch SW9. The signal amplification transistor M10 is a transistor for amplifying the pixel signal held in the capacitor CS1 and outputting the amplified signal. The output switch SW9 is a switch for transferring the pixel signal output from the signal amplification transistor M10 to a terminal S1. When the output switch SW9 changes to a conductive state due to a vertical scanning signal VSR input to the output switch SW9, the signal amplification transistor M10 and a constant current source CCSp (see FIG. 2A) in the output stage connected by a column signal line 406 form a source follower circuit. Consequently, the output unit OP1 amplifies the pixel signal held in the holding unit SH1 and outputs the amplified signal from the pixel P. In the following description, the pixel signal output from the pixel P and output from the terminal S1 after being amplified will be called a pixel signal S1. Also, the pixel signal S1 will be referred to as an image signal S1 when the pixel signal S1 is an accumulation signal based on irradiation, as a dark current signal S1 when the pixel signal S1 is a dark current signal when there is no irradiation, and as a reset signal S1 when the pixel signal S1 is a reset signal.

The holding unit SH2 is a unit which holds a pixel signal output from the amplification unit AP, and is a sample-and-hold circuit including a transfer transistor M11 and a capacitor CS2. More specifically, the pixel signal is transferred to and held in the capacitor CS2 by switching the states (the conductive state and the non-conductive state) of the transfer transistor M11 by using a sample-and-hold control signal TS2. The output unit OP2 includes a signal amplification transistor M13 and an output switch SW12. The signal amplification transistor M13 is a transistor for amplifying the pixel signal held in the capacitor CS2 and outputting the amplified signal. The output switch SW12 is a switch for transferring the pixel signal output from the signal amplification transistor M13 to a terminal S2. More specifically, when the output switch SW12 changes to a conductive state due to the vertical scanning signal VSR input to the output switch SW12, the signal amplification transistor M13 and the constant current source CCSp in the output stage connected by a column signal line 407 form a source follower circuit. Consequently, the output unit OP2 amplifies the pixel signal held in the holding unit SH2 and outputs the amplified signal from the pixel P. In the following description, the pixel signal output from the pixel P and output from the terminal S2 after being amplified will be called a pixel signal S2. Also, the pixel signal S2 will be referred to as an image signal S2 when the pixel signal S2 is an accumulation signal based on irradiation, as a dark current signal S2 when the pixel signal S2 is a dark current signal when there is no irradiation, and as a reset signal S2 when the pixel signal S2 is a reset signal.

The holding unit SH3 is a unit which can hold a pixel signal output from the amplification unit AP, and is a sample-and-hold circuit including a transfer transistor M14 and a capacitor CS3. More specifically, the pixel signal is transferred to and held in the capacitor CS3 by switching the states (the conductive state and the non-conductive state) of the transfer transistor M14 by using a sample-and-hold control signal TS3. The output unit OP3 includes a signal amplification transistor M16 and an output switch SW15. The signal amplification transistor M16 is a transistor for amplifying the pixel signal held in the capacitor CS3 and outputting the amplified signal. The output switch SW15 is a switch for transferring the pixel signal output from the signal amplification transistor M16 to a terminal S3. More specifically, when the output switch SW15 changes to a conductive state due to the vertical scanning signal VSR input to the output switch SW15, the signal amplification transistor M16 and the constant current source CCSp in the output stage connected by a column signal line 408 form a source follower circuit. Consequently, the output unit OP3 amplifies the pixel signal held in the holding unit SH3 and outputs the amplified signal from the pixel P. In the following description, the pixel signal output from the pixel P and output from the terminal S3 after being amplified will be called a pixel signal S3. Also, the pixel signal S3 will be referred to as an image signal S3 when the pixel signal S3 is an accumulation signal based on irradiation, as a dark current signal S3 when the pixel signal S3 is a dark current signal when there is no irradiation, and as a reset signal S3 when the pixel signal S3 is a reset signal.

After the pixel signals are sampled-and-held in the capacitors CS1, CS2, and CS3, the transfer transistors M8, M11, and M14 are turned off. Consequently, the capacitors CS1, CS2, and CS3 are disconnected from the amplification unit AP in the input stage. Therefore, the pixel signal (the image signal, dark current signal, or reset signal) held in each capacitor can nondestructively be read out without any influence from the input stage, until the next signal is sampled-and-held again.

Next, a pixel array 120 and a signal readout unit 20 connected to the pixel array 120 in the imaging apparatus 100 of this embodiment will be explained with reference to FIGS. 2A and 2B. In the pixel array 120, a plurality of pixels P shown in FIG. 1 are arranged in the form of a two-dimensional array. Signals from the pixel array 120 are read out by the signal readout unit 20 from terminals Es1, Es2, and Es3 of the pixel array 120. The pixel array 120 of the imaging apparatus 100 of this embodiment will be explained with reference to FIG. 2A. FIG. 2A is an example of a circuit diagram for explaining an outline of the arrangement of the pixel array 120 of the imaging apparatus 100 of this embodiment.

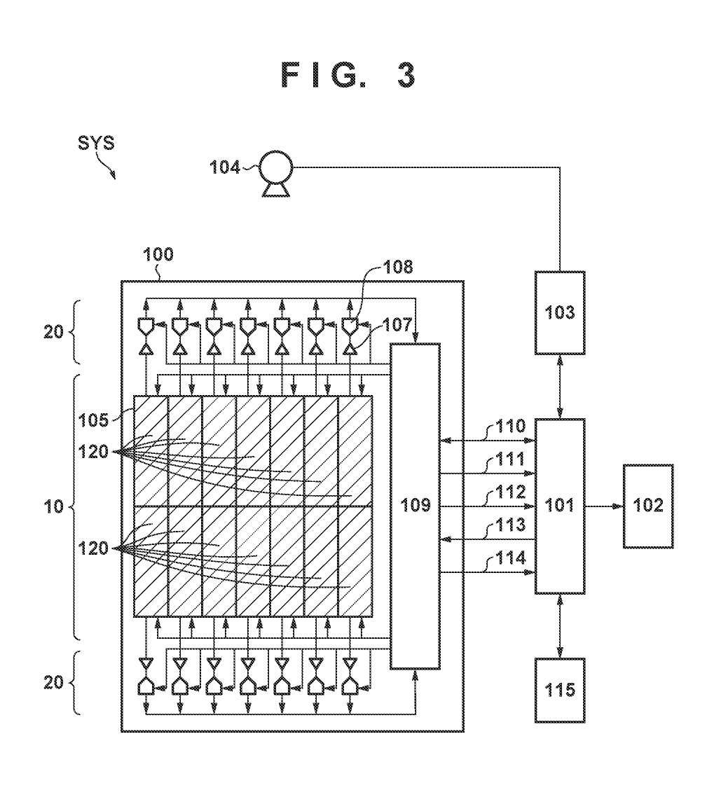

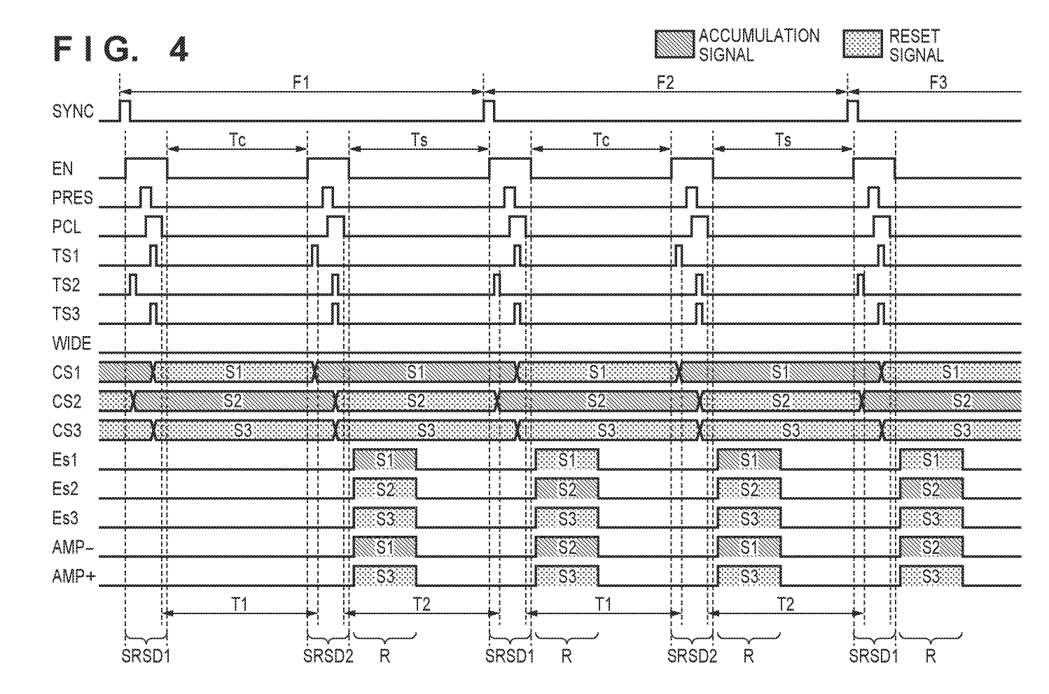

The pixel array 120 includes the plurality of pixels P, a vertical scanning circuit 403 for driving the pixels P, and a horizontal scanning circuit 404 for reading out signals from the pixels P. The vertical scanning circuit 403 and the horizontal scanning circuit 404 are formed by, for example, shift registers, and operate based on control signals from a control unit 109 (see FIG. 3). The vertical scanning circuit 403 supplies the vertical scanning signal VSR to the pixels P via a control line 405, and drives the pixels P row by row based on the vertical scanning signal VSR. That is, the vertical scanning circuit 403 functions as a row selector, and selects the pixels P as signal read targets row by row. Also, the horizontal scanning circuit 404 functions as a column selector. The horizontal scanning circuit 404 selects the pixels P column by column based on a horizontal scanning signal HSR, and outputs the signals from the pixels P in order. That is, the horizontal scanning circuit 404 controls so-called horizontal transfer. The operation frequency of the row selector (the vertical scanning circuit 403) is set to be lower than that of the column selector (the horizontal scanning circuit 404). That is, the operation of the row selector (the vertical scanning circuit 403) is made slower than that of the column selector (the horizontal scanning circuit 404).

The pixel array 120 includes the terminal Es1 for outputting a pixel signal held in the capacitor CS1 of each pixel P, the terminal Es2 for outputting a pixel signal held in the capacitor CS2, and the terminal Es3 for outputting a pixel signal held in the capacitor CS3. The pixel array 120 further includes a select terminal Ecs. When a signal received by the terminal Ecs is activated, pixel signals from selected pixels P of the pixel array 120 are read out from the terminals Es1, Es2, and Es3. More specifically, the above-described pixel signals S1, S2, and S3 of the pixels P are supplied to the column signal lines 406, 407, and 408 connected to the terminals S1, S2, and S3. These pixel signals supplied to the column signal lines 406 to 408 are input to amplification transistors Av formed in one-to-one correspondence with the column signal lines.

A control transistor SWch and a constant current source CCSv are connected in series with each amplification transistor Av so as to form a current path. The pixel signals S1 to S3 from selected pixels P are input to the amplification transistors Av via the column signal lines 406 to 408. Transfer transistors SWah are connected to the outputs of the amplification transistors Av, and analog signal lines 409 to 411 are connected to the outputs of the transfer transistors SWah. Signals from the amplification transistors Av are output to the analog signal lines 409 to 411 via the transfer transistors SWah which change to a conductive state in response to the horizontal scanning signal HSR from the horizontal scanning circuit 404. When the horizontal scanning signal HSR to be input to the gates of the control transistors SWch is activated, the amplification transistors Av which receive voltages from the column signal lines 406 to 408 are activated, thereby forming source follower circuits. The voltages output from the column signal lines 406 to 408 and amplified by the amplification transistors Av are output to the analog signal lines 409 to 411 via the transfer transistors SWah which change to a conductive state in response to the horizontal scanning signal HSR.

Amplification transistors Aout to which signals are input via the analog signal lines 409 to 411 and constant current sources CCSout are connected in series so as to form current paths, thereby forming source follower circuits. Consequently, the amplification transistors Aout amplify the voltages from the analog signal lines 409 to 411. The amplified voltages are output from the terminals Es1, Es2, and Es3 via transfer transistors SWcs which change to a conductive state in response to the signal input to the terminal Ecs.

The pixel array 120 further includes terminals HST, CLKH, VST, and CLKV which receive control signals for controlling the vertical scanning circuit 403 and the horizontal scanning circuit 404. The terminal HST receives a start pulse to be input to the horizontal scanning circuit 404. The terminal CLKH receives a clock signal to be input to the horizontal scanning circuit 404. The terminal VST receives a start pulse to be input to the vertical scanning circuit 403. The terminal CLKV receives a clock signal to be input to the vertical scanning circuit 403. These control signals are input from the control unit 109 (to be described later). The horizontal scanning circuit 404 generates and outputs the horizontal scanning signal HSR based on the input start pulse and clock signal. The vertical scanning circuit 403 generates and outputs the vertical scanning signal VSR based on the input start pulse and clock signal. Consequently, the pixel signals S1, S2, and S3 held in the capacities Cs1, Cs2, and Cs3 are sequentially read out from the pixels P by an X-Y address method. That is, in the pixel array 120, signals held in the pixels P are selected row by row and read out by outputting (horizontally transferring) signals held in the holding units column by column.

The signal readout unit 20 for reading out signals from the pixel array 120 of the imaging apparatus of this embodiment will be explained below with reference to FIG. 2B showing an outline of the arrangement of the signal readout unit 20 of the imaging apparatus of this embodiment. The signal readout unit 20, for example, includes a signal amplification unit 107 including a differential amplifier and the like, and an AD converter 108 for performing AD conversion. Pixel signals read out from the terminals Es1 to Es3 of the pixel array 120 are input to input terminals of the signal readout unit 20.

The pixel signal S3 from the terminal Es3 is input to a non-inverting input terminal AMP+ of the signal amplification unit 107. The pixel signal S1 from the terminal Es1 is input to an inverting input terminal AMP− of the signal amplification unit 107 via a switch M51. The switch M51 changes to a conductive state in response to a control signal TRO1 input to the control terminal of the switch M51. The pixel signal S2 from the terminal Es2 is input to the inverting input terminal AMP− via a switch M52. The switch M52 changes to a conductive state in response to a control signal TRO2 input to the control terminal of the switch M52. The switches M51 and M52 are so controlled that one of the signals from the terminals Es1 and Es2 is input to the inverting input terminal AMP− of the signal amplification unit 107. The switches M51 and M52 and the signal amplification unit 107 are so designed as to have response characteristics capable of following the cycle of a signal ADCLK.

The signal amplification unit 107 amplifies a difference between the signals from the terminals Es1 and Es3, or a difference between the signals from the terminals Es2 and Es3, in accordance with the operations of the switches M51 and M52. The AD converter 108 AD-converts the difference based on a clock signal input via the terminal ADCLK. In this arrangement as described above, image data (digital data) of the pixel array 120 is obtained and output to the control unit 109 (to be described later) via a terminal ADOUT.

The imaging apparatus 100 and a radiation imaging system SYS of this embodiment will be explained below with reference to FIG. 3.

The radiation imaging system SYS includes the imaging apparatus 100, a radiation generation unit 104 for generating radiation, an irradiation controller 103, a signal processing unit 101 for performing image processing and system control, and a display unit 102 including a display or the like. When performing imaging, the signal processing unit 101 synchronously controls the imaging apparatus 100 and the irradiation controller 103. The imaging apparatus 100 generates a signal based on radiation (for example, X-ray, α-ray, β-ray, or γ-ray) having passed through a subject, and the signal processing unit 101 or the like performs predetermined processing on this signal. After that, image data based on the radiation is generated. The display unit 102 displays this image data as a captured image. The imaging apparatus 100 includes an image sensing panel 105 having an image sensing region 10, the signal readout unit 20 for reading out a signal from the image sensing region 10, and the control unit 109 for controlling each pixel array 120.

The image sensing panel 105 may be configured by tiling (two-dimensionally arranging) a plurality of pixel arrays 120 on a plate-like base. The image sensing panel 105 having a large size can be formed by this configuration. As explained with reference to FIG. 2A, the plurality of pixels P are arranged in each pixel array 120. In the image sensing region 10, a plurality of pixels P are so arranged as to form rows and columns by the plurality of pixel arrays 120. In this embodiment, the plurality of pixel arrays 120 are so tiled as to form 7 columns×2 rows as an example. However, the present invention is not limited to this arrangement.

The control unit 109 exchanges control commands and sync signals with, for example, the signal processing unit 101. Also, the control unit 109 controls the pixel arrays 120 in the image sensing region 10 and the signal readout units 20, thereby performing, for example, setting of the reference voltage of each pixel array 120, driving control of each pixel, and operation mode control. In addition, the control unit 109 synthesizes one frame image by using the image data (digital data) of the pixel arrays 120, which are AD-converted by the AD converters 108 in the signal readout units 20, and outputs the frame image to the signal processing unit 101. The control unit 109 may also be configured by using a processor such as a CPU, and a memory such as a RAM or ROM. The operation of the imaging apparatus 100 may also be executed by the processor of the control unit 109 by executing a program stored in the memory. Instead, the control unit 109 may also be a dedicated circuit such as an ASIC (Application Specific Integrated Circuit). Likewise, the signal processing unit 101 may also be a computer including a processor such as a CPU and a memory such as a RAM or ROM, or a dedicated circuit such as an ASIC. The signal processing unit 101 can also be called an image generator because the signal processing unit 101 generates images (to be described later). A storage unit 115 capable of storing programs and data to be used in processing of the signal processing unit 101 is connected to the signal processing unit 101. The storage unit 115 may also be a magnetic disk, semiconductor drive, or the like.

The control unit 109 and the signal processing unit 101 exchange control commands or control signals and image data via various interfaces. The signal processing unit 101 outputs setting information or imaging information such as an operation mode and various parameters to the control unit 109 via a control interface 110. The control unit 109 outputs apparatus information such as the operation state of the imaging apparatus 100 to the signal processing unit 101 via the control interface 110. The control unit 109 also outputs image data obtained by the imaging apparatus 100 to the signal processing unit 101 via an image data interface 111. The control unit 109 can also notify the signal processing unit 101 that the imaging apparatus 100 is in an imaging enable state by using a READY signal 112. In response to the READY signal 112 from the control unit 109, the signal processing unit 101 can notify the control unit 109 of the start timing of irradiation by using a sync signal 113. The control unit 109 performs control by receiving the sync signal 113. An irradiation enable signal 114 is a signal for notifying the signal processing unit 101 that the image sensing panel 105 has made preparations for imaging. While the irradiation enable signal 114 is in an enable state, the signal processing unit 101 outputs a control signal to the irradiation controller 103 and causes the irradiation controller 103 to start irradiation.

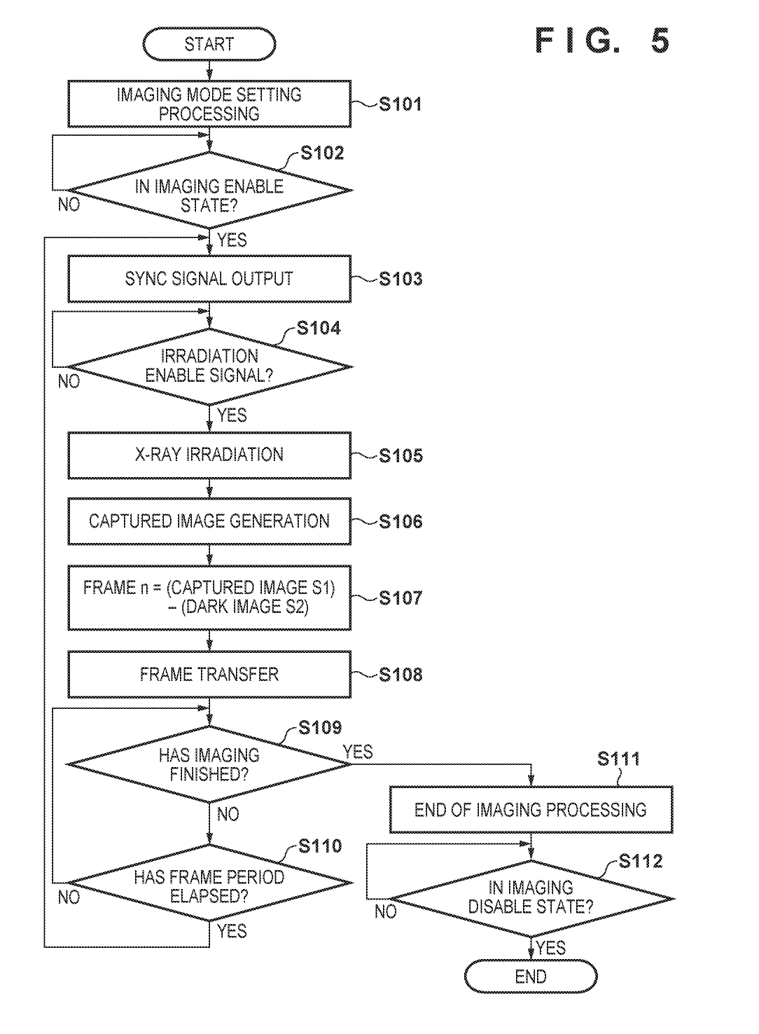

A method of driving the imaging apparatus 100 according to this embodiment will be explained by taking a timing chart shown in FIG. 4 as an example. The control unit 109 executes imaging by controlling the operation of each unit of the imaging apparatus 100. The imaging apparatus 100 can capture a moving image formed by a plurality of frame images.

Referring to FIG. 4, the horizontal axis indicates time, and the values of signals “SYNC” to “WIDE” indicate the levels of these signals. For example, the signal SYNC changes to H level at a cycle of F1, F2, F3 . . . . The signal WIDE remains at L level in FIG. 4. The signals “CS1”, “CS2”, and “CS3” indicate the types of signals held in the capacitors CS1, CS2, and CS3. The signals “Es1”, “Es2”, and “Es3” indicate the types and readout periods of signals to be read out from the holding units of the pixel array 120 to the signal readout unit 20. Periods in which the signals “Es1” to “Es3” are at H (High) level are periods during which a signal read operation is executed. A period in which “AMP−” is at H level is a period during which a signal is input to the inverting input terminal AMP− of the signal amplification unit 107. A period in which “AMP+” is at H level is a period during which a signal is input to the non-inverting input terminal AMP+ of the signal amplification unit 107. A period R is a period during which the output terminal of the signal amplification unit 107 outputs a signal.

The frame image rate is constant in FIG. 4. A period Tc and a period Ts after driving is performed in a driving period SRSD1 (to be referred to as “driving SRSD1” hereinafter) for performing a sample-and-hold operation and reset operation (to be described later) and a driving period SRSD2 (to be referred to as “driving SRSD2” hereinafter) for performing a sample-and-hold operation and reset operation are longer than the pixel signal readout period R. In this embodiment, a case in which an imaging mode of performing imaging at sensitivity obtained by adding no additional capacitor Cfd′ is set will be explained.

Frame periods F1 and F2 indicate the first and second frame periods after the start of imaging. A frame period is a period for generating a frame image and repeated in order to form a plurality of frame images.

An accumulation period T1 is a period during which irradiation is performed. The accumulation period T1 is also a period during which charges corresponding to the accumulation period T1 are accumulated in the photoelectric conversion element PD in each of the frame periods F1 and F2. The charges contain charges generated in accordance with irradiation, and dark charges other than those. During the accumulation period T1, the control unit 109 notifies the signal processing unit 101 that irradiation is possible by using the irradiation enable signal 114.

An accumulation period T2 is a period during which no irradiation is performed. The accumulation period T2 is a period during which dark charges based on a dark current corresponding to the accumulation period T2 are accumulated in the photoelectric conversion element PD in each of the frame periods F1 and F2. During the accumulation period T2, the control unit 109 notifies the signal processing unit 101 that irradiation is inhibited by using the irradiation enable signal 114. The control unit 109 controls the periods Tc and Ts based on the frame period calculated from the frame image rate, so that the accumulation periods T1 and T2 have the same length.

An imaging mode is initially set before imaging. For example, the sensitivity of the pixel P is set. This embodiment will be explained by taking, as an example, a case in which imaging is performed by using only the FD capacitor Cfd without adding the additional capacitor Cfd′ for sensitivity switching. In this case, the control unit 109 deactivates the control signal WIDE.

When imaging is started and the control unit 109 detects the leading edge of the pulse of the sync signal SYNC, imaging for generating a frame image in the first frame period F1 is started. During this imaging, the imaging operation is repeated such that one frame period F1 begins at the leading edge of the pulse of the SYNC signal and ends at the next leading edge of the SYNC signal, and the next frame period F2 begins. The SYNC signal can be either an externally received sync signal or an internally generated sync signal. This embodiment will be explained by assuming that the SYNC signal is an externally received sync signal.

The driving SRSD1 in the frame period F1 will be explained. The control unit 109 performs the driving SRSD1 to be explained below on all the pixels P included in the image sensing panel 105 at once. The driving SRSD1 is a period for performing a sample-and-hold operation and reset operation to be executed in, for example, the frame periods F1 and F2. In the sample-and-hold operation, sampling-and-holding for holding pixel signals in the capacitors CS1 to CS3 is performed. In the reset operation, the conversion unit CP and amplification unit AP are reset.

When detecting the leading edge of the pulse of the SYNC signal, the control unit 109 starts control for generating a frame image in the frame period F1. First, the control unit 109 activates the enable signal EN. Consequently, the control transistor M3 changes to a conductive state, and the amplification transistor M4 starts operating. The amplification transistor M4 amplifies the voltage from the conversion unit CP and outputs the amplified voltage. The output voltage from the amplification transistor M4 is also input to the amplification transistor M7 via the clamp capacitor Ccl. Since the enable signal EN sets the control transistor M6 in a conductive state, the amplification transistor M7 also starts operating. The amplification transistor M7 amplifies the voltage from the amplification transistor M4 and outputs the amplified voltage. Then, the control unit 109 temporarily activates the control signal TS2. Consequently, the transfer transistor M11 changes to a conductive state, so the output from the amplification transistor M7 is transferred as the pixel signal S2 to the capacitor CS2 and held in it. Note that in this embodiment, the pixel signal S2 obtained by the first driving SRSD1 of imaging is not used in processing after that.

Subsequently, the control unit 109 deactivates the control signal TS2 and then activates the reset voltage PRES. Consequently, the reset transistor M2 changes to a conductive state, the reset voltage VRES as a predetermined potential is supplied to the photodiode PD, and charges of the photodiode PD are reset. As a result, the voltage output from the conversion unit CP upon resetting is input to the input terminal n1 of the clamp capacitor Ccl. The control unit 109 then activates the clamp signal PCL. Consequently, the reset transistor M5 changes to a conductive state, and the clamp voltage VCL as a predetermined potential is input to the output terminal n2 of the clamp capacitor Ccl.

Then, the control unit 109 temporarily activates the control signals TS1 and TS3 in the period from activation to deactivation of the clamp signal PCL. Since the enable signal EN is activated and the amplification transistors M4 and M7 are operating, the amplification transistor M7 amplifies the signal output from the conversion unit CP upon resetting and outputs the amplified signal. Since the control signals TS1 and TS3 are activated, the transfer transistors M8 and M14 change to a conductive state, and the voltage output from the amplification transistor M7 is transferred as the reset signals S1 and S3 to the capacitors CS1 and CS3 and held in them. That is, reset signal sampling is performed.

The control unit 109 deactivates the reset voltage PRES while temporarily activating the control signals TS1 and TS3. This changes the reset transistor M2 to a non-conductive state. The control unit 109 deactivates the control signals TS1 and TS3 and then deactivates the clamp signal PCL. Consequently, the reset transistor M5 changes to a non-conductive state, and a potential difference produced between the input terminal n1 and the output terminal n2 of the clamp capacitor Ccl is held in the two terminals of the clamp capacitor Ccl. After the clamp signal PCL is deactivated, the accumulation period T1 during which charges are accumulated in the photoelectric conversion element PD begins. After deactivating the clamp signal PCL, the control unit 109 deactivates the enable signal EN. This is the end of the driving SRSD1 in the frame period F1. In the frame period F1, no pixel signal is read out because no effective accumulation signal is held in the capacitor CS2.

Next, the driving SRSD2 in the frame period F1 will be explained. The control unit 109 performs the driving SRSD2 to be explained below on all the pixels P included in the image sensing panel 105 at once. The driving SRSD2 is a period for performing a sample-and-hold operation and a reset operation. In the driving SRSD2, the image signals accumulated in the period T1 is sampled-and-held in capacitors. This will be explained in detail below.

When the period Tc elapses after the driving SRSD1 in the frame period F1 is complete, the control unit 109 starts driving for generating a frame image in the frame period F1. First, the control unit 109 activates the enable signal EN. Then, the control unit 109 temporarily activates the control signal TS1. Consequently, the voltage amplified by the amplification transistors M4 and M7 is transferred as the image signal S1 to the capacitor CS1 via the transfer transistor M8 and held in the capacitor CS1.

Subsequently, the control unit 109 deactivates the control signal TS1, activates the reset voltage PRES, and activates the clamp signal PCL. The control unit 109 temporarily activates the control signals TS2 and TS3 until deactivation of the clamp signal PCL. Consequently, the output from the amplification transistor M7 is transferred as the reset signals S2 and S3 to the capacitors CS2 and CS3 and held in them. That is, reset signal sampling is performed.

While temporarily activating the control signals TS2 and TS3, the control unit 109 deactivates the reset voltage PRES. This changes the reset transistor M2 to a non-conductive state. The control unit 109 deactivates the control signals TS2 and TS3, and deactivates the clamp signal PCL after that. Consequently, the reset transistor M5 changes to a non-conductive state, and a potential difference produced between the input terminal n1 and the output terminal n2 of the clamp capacitor Ccl is held at the two terminals of the clamp capacitor Ccl. When the clamp signal PCL is deactivated, the accumulation period T2 during which charges are accumulated in the photoelectric conversion element PD begins. After deactivating the clamp signal PCL, the control unit 109 deactivates the enable signal EN. This is the end of the driving SRSD2 in the frame period F1.

An operation of reading out the image signal S1 and the reset signal S3 in the period Ts of the frame period F1 will be explained with reference to FIG. 4. In this embodiment, the signal readout unit 20 starts reading out the image signal S1 and the reset signal S3 when a predetermined time elapses after the image signal S1 is held. When the driving SRSD2 ends in the frame period F1, the image signal S1 corresponding to the accumulation period T1 of the frame period F1 is held in the capacitor CS1, and the reset signals S2 and S3 as a predetermined potential are held in the capacitors CS2 and CS3. Therefore, the control unit 109 starts reading out the image signal S1 and the reset signal S3 held in these capacitors when a predetermined time elapses after the completion of the driving SRSD2. More specifically, the control unit 109 activates the select terminal Ecs of the pixel array 120, and activates the control signal TRO1 of the signal readout unit 20. At this timing, the control signal TRO2 is deactivated. The transfer transistor SWcs is turned on, and the output from the amplification transistor Aout appears at the terminal Es1 to Es3. Also, the switch M51 is turned on, and the switch M52 is turned off, so the signal from the terminal Es1 is input to the non-inverting input terminal of the signal amplification unit 107.

Subsequently, the control unit 109 selects a predetermined row of the pixel array 120 by controlling the vertical scanning circuit 403, and selects a predetermined column by controlling the horizontal scanning circuit 404, thereby selecting one of the plurality of pixels P included in the pixel array 120. Signals held in the selected pixel P are output from the terminals Es1 to Es3 of the pixel array 120. Consequently, the image signal S1 held in the selected pixel P is input to the inverting input terminal AMP− of the signal amplification unit 107, and the reset signal S3 held in the selected pixel P is input to the non-inverting input terminal AMP+ of the signal amplification unit 107. In the frame period F1, therefore, the signal readout unit 20 reads out the image signal S1 and the reset signal S3 of the selected pixel P at the same timing.

The control unit 109 reads out the image signal S1 and the reset signal S3 held in the capacitors of the selected pixel P through two systems of pixel signal paths (differential signal paths) including the internal column signal lines of the pixel array 120, and outputs the readout signals to the signal amplification unit 107 of the signal readout unit 20. The signal amplification unit 107 having received the output from the pixel array 120 outputs a signal obtained by calculating the difference between the image signal S1 and the reset signal S3. This output signal from the signal amplification unit 107 is equivalent to a pixel signal obtained by correcting the offset of the two systems of signal paths by differential input. Noise contained in the two systems of signal paths remains.

The AD converter 108 converts the output signal into digital data and supplies the data to the control unit 109. The control unit 109 sequentially switches pixels to be selected by controlling the vertical scanning circuit 403 and the horizontal scanning circuit 404, obtains digital data for generating an image in the period R of the period Ts, and generates a frame image corresponding to the accumulation period T1 of the frame period F1. This image generated based on the accumulation signal read out from each pixel as described above will be called an accumulation image hereinafter.

The driving SRSD1 in the frame period F2 will be explained below with reference to FIG. 4. Note that the same operations as in the frame period F1 will be omitted. In the driving SRSD1 in the frame period F2, the dark current signal accumulated in the period T2 of the frame period F1 during which no irradiation is performed is read out. The driving SRSD1 is also performed on all the pixels P included in the image sensing panel 105 at once. First, the control unit 109 activates the enable signal EN, and then temporarily activates the control signal TS2. Consequently, the transfer transistor M11 switches from a non-conductive state to a conductive state, and the dark current signal S2 accumulated in the accumulation period T2 of the frame period F1 is transferred to and held in the capacitor CS2. That is, sampling of the accumulation signal (dark current signal) is performed.

Then, the control unit 109 sequentially activates the reset voltage PRES and the clamp signal PCL in the same manner as in the frame period F1. The control unit 109 temporarily activates TS1 and TS3, and holds the reset signals S1 and S3 in the capacitors CS1 and CS3. Subsequently, the control unit 109 sequentially deactivates the reset voltage PRES and the clamp signal PCL. When the clamp signal PCL is deactivated, the accumulation period T1 of the frame period F2 begins. After that, the control unit 109 deactivates the enable signal EN, and terminates the driving SRSD1 in the frame period F2.

An operation of reading out the dark current signal S2 and the reset signal S3 in the period Tc of the frame period F2 will be explained below. In this embodiment, the signal readout unit 20 starts reading out the dark current signal S2 and the reset signal S3 when a predetermined time elapses after the dark current signal S2 is held.

At the end of the driving SRSD1 in the frame period F2, a potential corresponding to the dark current signal S2 corresponding to the accumulation period T2 of the frame period F1 is held in the capacitor CS2, and the reset signals S1 and S3 as a predetermined potential are held in the capacitors CS1 and CS3. When a predetermined time elapses after the end of the driving SRSD1, therefore, the control unit 109 starts reading out the dark current signal S2 and the reset signal S3 held in these capacitors.

More specifically, the control unit 109 deactivates the control signal TRO1, and activates the select terminal Ecs and the control signal TRO2. Subsequently, the control unit 109 selects one of the plurality of pixels P included in the pixel array 120 by controlling the vertical scanning circuit 403 and the horizontal scanning circuit 404. Consequently, the dark current signal S2 held in the selected pixel P is input to the inverting input terminal AMP− of the signal amplification unit 107, and the reset signal S3 held in the selected pixel P is input to the non-inverting input terminal AMP+ of the signal amplification unit 107. Thus, the signal readout unit 20 reads out the dark current signal S2 and the reset signal S3 at the same timing.

The control unit 109 reads out the dark current signal S2 and the reset signal S3 held in the capacitors through two systems of pixel signal paths (differential signal paths) in the pixel array 120, and outputs the readout signals to the signal amplification unit 107. The signal amplification unit 107 receiving the output from the pixel array 120 outputs a signal obtained by calculating the difference between the dark current signal S2 and the reset signal S3.

The AD converter 108 converts the output signal into digital data and supplies the data to the control unit 109. The control unit 109 sequentially switches pixels to be selected by controlling the vertical scanning circuit 403 and the horizontal scanning circuit 404, obtains digital data for generating an image in the period R of the period Tc, and generates an image corresponding to the accumulation period T2 of the frame period F1. An image generated based on the accumulation signal accumulated in the accumulation period T2 and read out from each pixel will also be called an accumulation image hereinafter. Signal accumulation is performed in each of the accumulation period T1 during which the imaging apparatus 100 is irradiated, and the accumulation period T2 during which the imaging apparatus 100 is not irradiated. For the sake of explanation, an accumulation image generated in the state in which the imaging apparatus 100 is not irradiated will be called a dark image hereinafter, and an accumulation image generated in the state in which the imaging apparatus 100 is irradiated will be called a captured image hereinafter.

Subsequently, the same driving SRSD2 as that in the frame period F1 is performed in the frame period F2 as well. In the driving SRSD2, the image signal S1 corresponding to the accumulation period T1 of the frame period F2 is transferred to and held in the capacitor CS1, and the reset signals S2 and S3 are transferred to and held in the capacitors CS2 and CS3. When the driving SRSD2 ends, the control unit 109 obtains digital data for generating an accumulation image in the period R of the period Ts by sequentially switching pixels to be selected, and generates an accumulation image (captured image) corresponding to the accumulation period T1 of the frame period F2.

Then, the same driving SRSD1 and the driving SRSD2 are performed in frame periods from the frame period F3 as well. For example, in the driving SRSD1, the dark current signal S2 corresponding to the accumulation period T2 of an immediately preceding frame period is transferred to and held in the capacitor CS2, and the reset signals S1 and S3 are transferred to and held in the capacitors CS1 and CS3. When the driving SRSD1 ends, the control unit 109 sequentially switches pixels to be selected, obtains digital data for generating an accumulation image in the period R, and generates an accumulation image (dark image) corresponding to the accumulation period T2 of an immediately preceding frame period.

Subsequently, in the driving SRSD2, the image signal S1 corresponding to the accumulation period T1 of a frame period during which this driving is performed is transferred to and held in the capacitor CS1, and the reset signals S2 and S3 are transferred to and held in the capacitors CS2 and CS3. When the driving SRSD2 ends, the control unit 109 reads out pixel signals by sequentially switching pixels to be selected, and generates an accumulation image (captured image) corresponding to the accumulation period T1 of the frame period during which the driving SRSD2 is performed in the period R. Thus, accumulation signal holding and reset signal holding are performed between two consecutive reset operations.

The captured images and dark images are sequentially generated as described above. Noise removal using the captured images and dark images will be explained below. In the following explanation, the accumulation image S1 is, for example, a captured image based on signals accumulated in the period T1 of the frame period F1, and corresponds to the signal to be read out in the driving SRSD2 of the frame period F1. The accumulation image S2 is a dark image based on signals accumulated in the period T2 of the frame period F1, and corresponds to the signal to be read out in the driving SRSD1 of the frame period F2. For the sake of explanation, the accumulation image S1 will be called a captured image S1 and the accumulation image S2 will be called a dark image S2 hereinafter.

The pixel signal paths in the pixel array 120 include semiconductor elements such as amplification transistors, constant current sources, and switches in addition to signal lines, and generate different 1/f noise components and different temperature drifts caused by the individual semiconductor elements. Semiconductors of the signal amplification unit 107 and the AD converter 108 forming the signal readout unit 20 contain noise components such as the 1/f noise and temperature drift. That is, in a signal to be generated, noise components generated in the signal readout unit 20 are superposed on noise generated in the internal signal paths of the pixel array 120.

In the above-described example, a method of differentially transmitting readout signals is performed. Offset, 1/f noise, and temperature drift unique to a semiconductor element in each differential transmission path exist. The difference between differential signals is superposed on a generated image, and appears as a unique artifact, random noise, vertical line noise, or a block-like artifact in the image.

In image correction, it is possible to generate a dark image immediately before the start of imaging in order to sufficiently correct the 1/f noise of a semiconductor element which fluctuates with time. Even when imaging modes are limited to a few types, however, dark image generation including accumulation takes time, and a time lag occurs at the start of imaging especially when generating a dark image at the start of imaging.

Also, the influence of low-frequency noise on an image changes from one place to another of a circuit where a semiconductor element is used. For example, the low-frequency noise of the amplification transistors M10, M13, and M16 of the pixel circuit P of the pixel array 120 exerts influence as random noise on an image. The low-frequency noise of the constant current source CCSp, the amplification transistor Av, and the constant current source CCSv to be used to amplify pixel signals on the column signal lines 406 to 408 of the pixel array 120 exerts influence as vertical line noise on an image. The low-frequency noise of the amplification transistor Aout and the constant current source CCSout to be used to amplify pixel signals on the analog signal lines 409 to 411 is superposed on the whole area of the pixel array, thereby exerting influence as block-like artifact on an image. Likewise, the low-frequency noise of the signal amplification unit 107 and the AD converter 108 is superposed on the whole area of the pixel array, thereby exerting influence as block-like artifact on an image. Especially in 3D imaging using a large-area flat panel sensor, it is known that vertical line noise and block-like artifact generate ring artifact in a 3D reconstructed image, and exert influence on an image more than random noise.

In this embodiment, a frame image is generated based on an accumulation image and dark image generated based on an accumulation signal accumulated for the same period in each frame period. This makes it possible to correct vertical line noise and block-like artifact generated due to noise such as 1/f noise or temperature drift.

A process of obtaining an accumulation image and dark image in synchronism with irradiation during imaging and correcting the accumulation image by using the dark image will be explained with reference to FIG. 5 showing an example of the process.

In step S101, the signal processing unit 101 issues a control command to the control unit 109, and sets an imaging mode. After that, the signal processing unit 101 changes the imaging apparatus 100 to an imaging enable state by a control command.

In step S102, the signal processing unit 101 determines whether the imaging apparatus 100 has changed to the imaging enable state by the READY signal 112. If the READY signal 112 is activated and it is determined that the imaging apparatus 100 is in the imaging enable state, the signal processing unit 101 starts imaging.

In step S103, the signal processing unit 101 outputs the sync signal pulse SYNC to the control unit 109. Upon receiving the sync signal pulse SYNC, the control unit 109 starts driving the image sensing panel 105 in accordance with the timing chart shown in FIG. 4, and outputs the irradiation enable signal 114 to the signal processing unit 101 for the accumulation period T1 set in step S101. In step S104, the signal processing unit 101 checks the irradiation enable signal 114. If the irradiation enable signal 114 is activated and the irradiation enable state is detected, the process advances to step S105, and the signal processing unit 101 outputs a control signal to the irradiation controller 103 so as to perform irradiation in synchronism with the accumulation period T1.

In step S106, the control unit 109 AD-converts, within a frame period, an accumulation signal held in each pixel, and transfers the signal as pixel data of an accumulation image to the signal processing unit 101. The signal processing unit 101 generates a captured image S1 based on the sequentially transferred pixel data, and temporarily holds the captured image S1 in the storage unit 115.

Then, in step S107, the control unit 109 AD-converts, within a frame period, a dark current signal held in each pixel in the dark current accumulation period T2, and transfers the signal as pixel data of the dark image S2 to the signal processing unit 101. Based on the sequentially transferred pixel data, the signal processing unit 101 reads out pixel data of the captured image S1 having the same pixel position from the storage unit 115, and generates a frame image while subtracting the pixel data of the dark image S2 from the pixel data of the captured image S1.

In step S108, the generated frame image is transferred to a post-step. In this post-step, image processing such as a gain correction process and sharpening process are performed on the transferred frame image in parallel to imaging by a pipeline method. If imaging is performed for real-time image observation such as fluoroscopic radiography, the processed image is transferred to and displayed on the display unit 102. If imaging is performed for processing based on a plurality of images such as 3D radiography, the frame image having undergone the image processing is stored in the storage unit 115.

In step S109, the signal processing unit 101 determines whether to terminate imaging, based on the state of a switch (not shown) for designating radiation fluoroscopy or a programmed number of captured images. If imaging is to be continued, the signal processing unit 101 checks the elapse of the frame period in step S110. If it is determined that imaging is complete, the process advances to step S111, and the signal processing unit 101 issues a control command indicating the end of image generation in the present imaging mode to the control unit 109 via the control interface 110, thereby performing an imaging terminating process.

If it is determined in step S110 that the frame period has not expired, the signal processing unit 101 performs the determination process in step S109 again. If it is determined that the frame period has expired, the signal processing unit 101 performs imaging of the next frame from step S103. The signal processing unit 101 continues processing the obtained images until the end of imaging.

In this example of the flowchart shown in FIG. 5, the signal processing unit 101 performs the process of subtracting the pixel data of the dark image S2 from the pixel data of the captured image S1 in the processing of step S107. However, the control unit 109 may also perform this subtraction. In this case, a storage unit (not shown) for temporarily storing the captured image S1 is formed in the control unit 109, and the captured image S1 read out first in the frame period is stored in this storage unit. Then, the pixel data of the dark image S2 read out from the image sensing panel 105 is subtracted from the pixel data of the captured image S1 read out from the storage unit, and the processed pixel data is transferred to the signal processing unit 101. Note that the processing of the signal processing unit 101 in step S107 generates a frame image while subtracting the pixel data of an image for correction corresponding to the transferred pixel data.

In addition to an offset generated in the conversion unit CP and the amplification unit AP, an offset generated in the readout system is superposed on the captured image S1 obtained in step S106. This offset generated in the readout system is superposed on the dark image S2 obtained in step S107 as well, in addition to the offset generated in the conversion unit CP and the amplification unit AP. By subtracting the dark image S2 from the accumulation image S1 in step S107, it is possible to cancel out the offset component of the image readout system and the offset component of the conversion unit CP and the amplification unit AP, and generate a frame image in which noise and artifact are sufficiently suppressed. Since the capacitors CS1 to CS3 can be separated by the transfer transistors M8, M11, and M14, pixel signals are held in the capacitors CS1 to CS3 until the transfer transistors M8, M11, and M14 are turned on for the next time. Therefore, the signal generation unit exerts no influence on accumulation signal read out.

### Second Embodiment

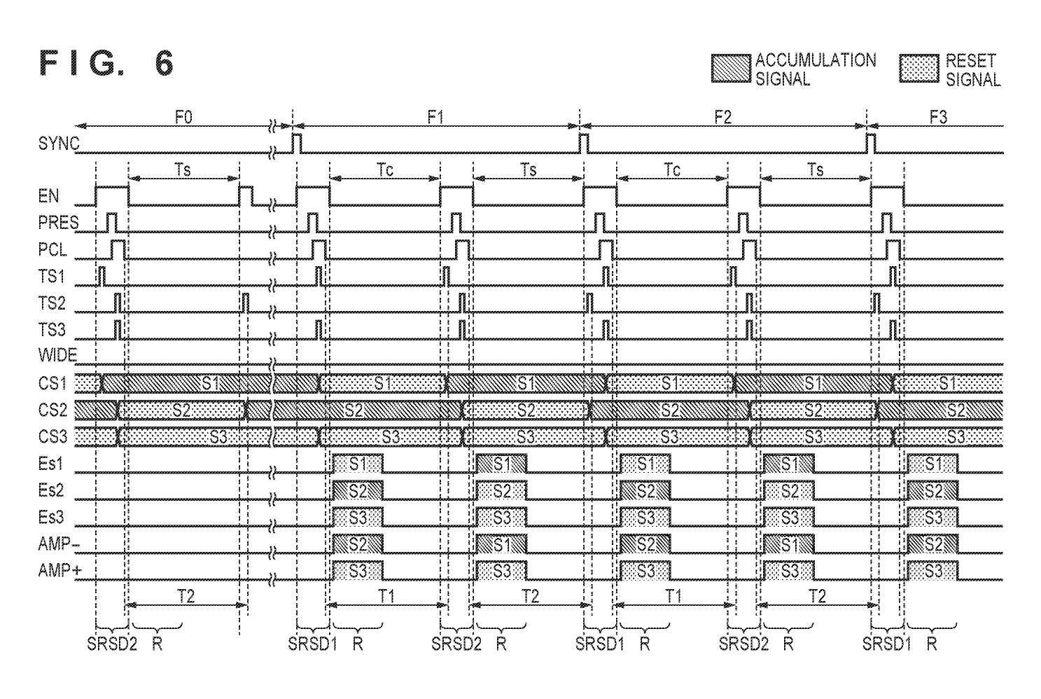

The difference of this embodiment from the first embodiment is the order of generation of a captured image and dark image in one frame period. In the first embodiment, a 0.5-frame delay is generated from the start of irradiation to actual imaging because a dark image to be used in correction is sensed after a captured image is obtained. An operation of obtaining a dark image before imaging will be explained below with reference to FIG. 6. In this embodiment, the configuration of an imaging apparatus and a driving method of obtaining and generating an image are almost the same as those of the first embodiment. A practical difference is that a dark image corresponding to a frame period F0 before the start of imaging is formed in the frame period F0. That is, in the frame period F0 before the start of imaging, a control unit 109 sequentially switches pixels to be selected in the period T2 between the end of driving SRSD2 and the start of next driving SRSD1. Digital data for generating a dark image is obtained in a period R of the frame period F0, and a dark image corresponding to the frame period F0 before the start of imaging is generated.

Since the timing of inputting of a radiation sync signal SYNC to the control unit is not determined, the timing of obtaining an accumulated dark current signal is sometimes not immediately before an accumulation signal. Therefore, the frame period F0 is repeated at a predetermined cycle until a sync signal is input, thereby updating a dark current signal to be accumulated.

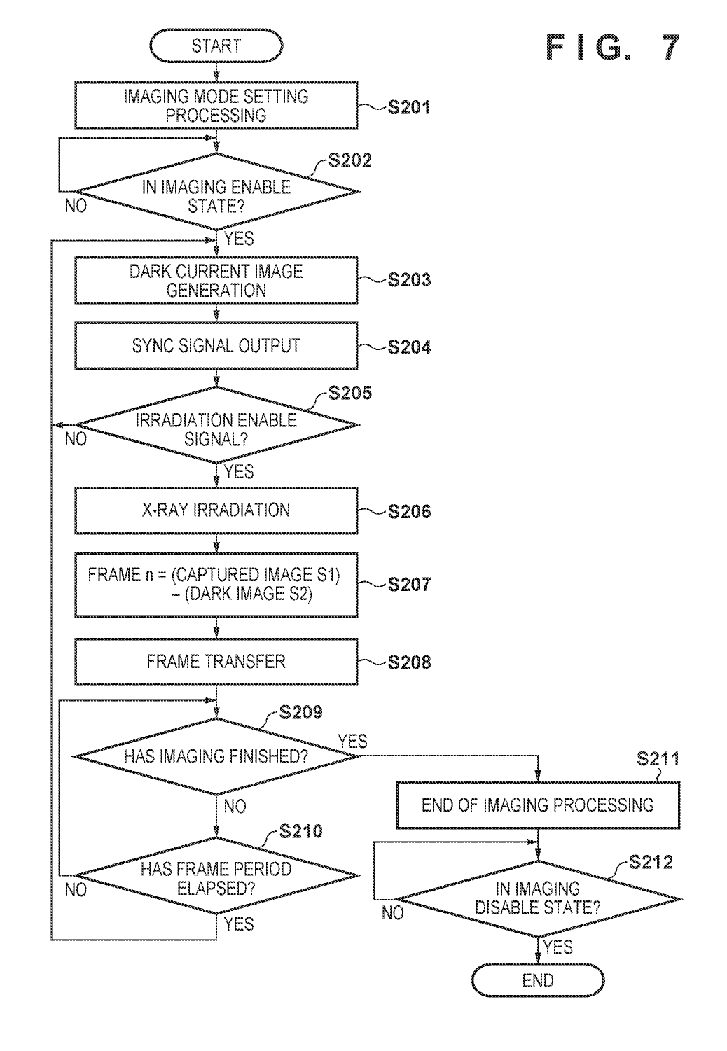

FIG. 7 is a flowchart showing an example of the imaging process of the second embodiment. The difference from the first embodiment is that the order of obtaining and generating a captured image and dark image is reversed as described above, and the rest of the processing is almost the same as that of the first embodiment. More specifically, in step S202, a signal processing unit 101 determines whether an imaging apparatus 100 has changed to an imaging enable state by using a READY signal 112. If the imaging apparatus 100 is in the imaging enable state, the process advances to step S203, and the control unit 109 AD-converts a dark current signal held in each pixel and transfers the signal as pixel data of a dark image to the signal processing unit 101, before the signal processing unit 101 outputs the sync signal pulse SYNC to the control unit 109. The signal processing unit 101 generates a dark image based on the sequentially transferred pixel data, and temporarily holds the dark image in a storage unit 115.

Then, the signal processing unit 101 outputs the sync signal pulse SYNC to the control unit 109 in step S204, and outputs a control signal to a radiation controller 103 in step S105 so as to perform irradiation in synchronism with an accumulation period T1. If no radiation sync signal is input for half the frame period, accumulation of the dark image is insufficient, so the process restarts from accumulation of the dark current signal in step S203.

After that, a captured image S1 is obtained in the same manner as in the first embodiment. In step S207, the control unit 109 AD-converts the accumulation signal held in each pixel within a frame period, and transfers the signal as pixel data of a captured image to the signal processing unit 101. Based on the sequentially transferred pixel data, the signal processing unit 101 generates a frame image while subtracting the pixel data of the temporarily stored dark image S2 for correction from the pixel data of the captured image S1.

If it is determined in step S210 that the frame period has not expired, a determination process in step S209 is performed again. If it is determined that the frame period has expired, imaging of the next frame is started from step S203.

### Modification of Second Embodiment

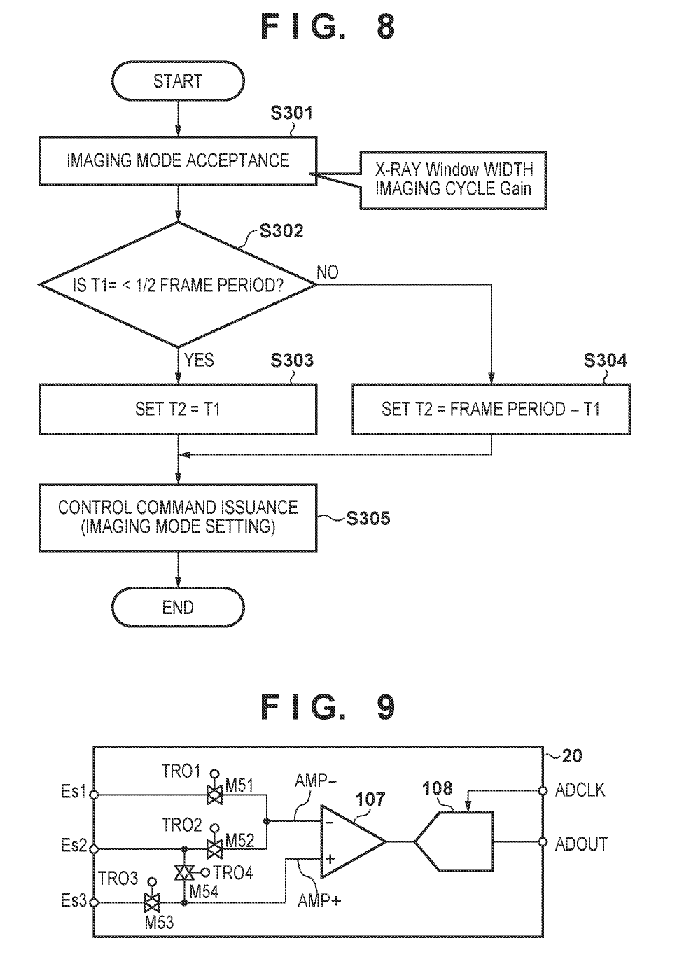

In the above-described embodiment, the imaging times of the captured image and dark image are almost the same, and the sum of the imaging times matches the frame period. When the accumulation time during which images are accumulated is not about half the frame period depending on an imaging mode with respect to a cycle determined by the frame period, a dark current accumulation time T2 is calculated as shown in a flowchart of FIG. 8, and the next control is performed. FIG. 8 is a flowchart related to details of the imaging mode setting in step S101 of FIG. 5 and step S201 of FIG. 7 described above.

In step S301, the signal processing unit 101 accepts imaging mode input such as an X-ray window width, imaging cycle, and gain from the user.

Then, in step S302, the signal processing unit 101 performs the next setting based on information of the input X-ray window width and imaging cycle.

1. When Accumulation Time (T1)<½ Frame Period

When correcting a captured image by using a dark image, the conditions are desirably the same except irradiation. Accordingly, the accumulation time T1 of irradiation and the accumulation time T2 of a dark current are desirably the same. In this case, the timings of an enable signal EN and a sample-and-hold control signal TS2 are varied so that accumulation period T1=dark current accumulation period T2 in step S303.

2. When Accumulation Time (T1)>½ Frame Period

Under this condition, the dark current accumulation time T2 cannot be the same as the irradiation accumulation time T1 because one frame period is exceeded. Therefore, the dark current accumulation time T2 is shortened so that the sum of the irradiation accumulation time T1 and the dark current accumulation time T2 matches the frame period in step S304. In this case, the time characteristics of the values of a dark image are held in the form of a table, and coefficient correction is performed on the formed dark image, thereby forming a corrected image equivalent to the accumulation time of irradiation. Note that the irradiation accumulation time cannot be longer than a time obtained by subtracting the transfer period R from the frame period, so at least a period equivalent to the transfer period R can be the period T2. Accordingly, the dark current accumulation time does not extremely shorten.

Then, in step S305, the signal processing unit 101 issues a control command for setting an imaging mode to the control unit 109.

### Third Embodiment

In the first and second embodiments, the image signal and dark current signal are transferred to the control unit, and image data is generated whenever these signals are transferred. In these embodiments, the frame rate cannot be increased more than a predetermined value due to the limitation on the data transfer time even when the accumulation time T1 is short. In this embodiment, a configuration which shortens the transfer time by calculating the difference between an accumulation signal and dark current signal before data transfer will be explained.

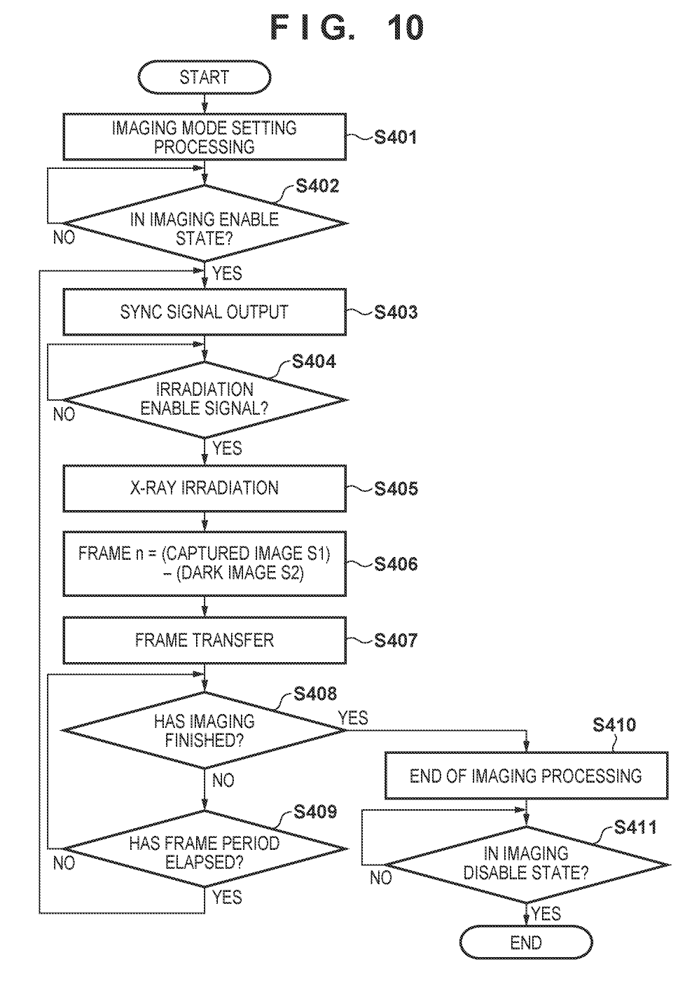

The difference from the above-described embodiments is the arrangement from output terminals Es1 to Es3 of S1 to S3 to a signal amplification unit 107 shown in FIG. 2B. The arrangement of the signal readout unit of this embodiment is shown in FIG. 9. The difference from FIG. 2B is that switches M54 are added between the terminal Es3 and the signal amplification unit 107 and between the terminals Es2 and Es3. In this arrangement, a pixel signal S2 from the terminal Es2 is input to a non-inverting input terminal AMP+ via the switch M54. Switches M52 and M53 are exclusively controlled with respect to the switches M54, and switch control signals TRO1 to TRO4 are so controlled that a captured signal is input to an inverting input terminal AMP− and a dark current signal is input to the non-inverting input terminal AMP+. Consequently, an accumulation signal can be corrected in a signal readout unit. That is, an accumulation signal obtained in a period T2 of a frame period F1 shown in FIG. 4 is held in a capacitor CS1, and an accumulation signal obtained in a period T1 of a frame period F2 shown in FIG. 4 is held in a capacitor CS2. It is possible to reduce the number of times of data transfer and increase the frame rate by performing correction which calculates the difference between two accumulation signals in a signal readout unit 20.

In this arrangement, however, only corrected accumulation images are transferred, so an average image of dark images (to be described later) cannot be formed. It is favorable to selectively perform the control of the first or second embodiment when the accumulation time is long or the image quality is given priority, and the control of the third embodiment when giving priority to the speed.

As described in the above embodiments, a frame image is formed in one frame period by nondestructively reading out the accumulation image and dark image by using the two sets of signal lines. This not only makes it possible to form the accumulation image without decreasing the frame rate, but also obviates the need for a conventionally necessary idling time for obtaining an image for correction.

### OTHER EMBODIMENTS

The differential read out method is disclosed in the first to third embodiments, but a single-end read out method may also be used instead of differential read out. In addition, an example in which an image signal is obtained by T1 and a dark current signal is obtained by T2 is disclosed in the above-described embodiments. However, it is also possible to obtain a dark current signal by T1 and an image signal by T2 by changing the order. In this case, the terminal names and signal names described in the embodiments are switched in the operation.

Furthermore, an example in which one set of signal lines is used for each of an image signal and dark current signal is disclosed in the above-described embodiments. However, it is also possible to use a plurality of signal lines and produce a difference between the accumulation times. This makes it possible to sample-and-hold both a high-sensitivity signal and low-sensitivity signal, and extend the dynamic range.

Also, a method of calculating the difference between an accumulation image and dark image in each frame period is disclosed in the first and second embodiments. However, a dark image to be used to correct an accumulation image is obtained whenever irradiation is performed, that is, obtained a plurality of times, and a moving average image of the obtained images is formed by calculation. Random noise can further be reduced by thus correcting an accumulation image by updating the moving average image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-008165, filed, Jan. 22, 2018, which is hereby incorporated by reference herein in its entirety.

What is claimed is:

1. An imaging apparatus comprising:
a pixel array in which a plurality of pixels are two-dimensionally arranged, each of the plurality of pixels including a conversion unit configured to convert radiation or light into charges, an amplification unit configured to amplify a signal corresponding to the charges, a reset unit configured to reset the conversion unit and the amplification unit, and first and second holding units configured to hold the amplified signal; and
a control unit configured to control the pixel array,
the control unit repetitively performing control including first control in which, between two consecutive reset operations performed by the reset unit, a first signal corresponding to charges converted by the conversion unit in a first period during which the pixel array is irradiated by radiation or light is held in the first holding unit, and second control which is different from the first control and in which, between two consecutive reset operations performed by the reset unit, a second signal corresponding to charges in the conversion unit in a second period during which the pixel array is not irradiated by radiation or light is held in the second holding unit,
wherein a captured image is generated based on the first signal, a dark image is generated based on the second signal, and the captured image is corrected by the dark image.

2. The apparatus according to claim 1, wherein the pixel further includes a third holding unit configured to hold a third signal corresponding to charges in the conversion unit when the conversion unit and the amplification unit are reset.

3. The apparatus according to claim 1, wherein the first period and the second period are equal.

4. The apparatus according to claim 1, wherein the control unit detects a sync signal indicating a timing at which the pixel array is irradiated by radiation or light, and adjusts a length of the second period based on a cycle of the sync signal and a length of the first period.

5. The apparatus according to claim 1, wherein
the correction of the captured image includes obtaining the dark image a plurality of times in accordance with being repetitively irradiated by the radiation, and correcting the captured image by an average dark image calculated from the dark images obtained the plurality of times, and
the average dark image is updated whenever a dark image is obtained.

6. The apparatus according to claim 1, wherein the second signal is obtained before emission of the radiation or light is started.

7. The apparatus according to claim 1, wherein the control unit reads out the second signal from the second holding unit in the first period, and reads out the first signal from the first holding unit in the second period.

8. The apparatus according to claim 1, wherein the control unit reads out a difference between the first signal held in the first holding unit and the second signal held in the second holding unit.

9. A radiation imaging system comprising:
a radiation generation unit configured to generate radiation; and
an imaging apparatus defined in claim 1.
